(19) United States
(12) Patent Application Publication
(10) Pub. No.: US 2018/0260542 A1
(43) Pub. Date: Sep. 13, 2018

(54) System And Method For Assessment Of Risk

(71) Applicant: Larvol, San Francisco, CA (US)

(72) Inventor: Bruno Larvol, San Francisco, CA (US)

(73) Assignee: Larvol, San Francisco, CA (US)

(21) Appl. No.: 15/212,197

(22) Filed: Jul. 16, 2016

(51) Int. Cl. G06F 21/31; G06F 21/62; G06F 21/60; H04L 12/58

(52) U.S. Cl. CPC G06F 21/316; H04L 51/30; G06F 21/606; G06F 21/6245

(57) ABSTRACT

A method is provided. The method comprises a computer calculating a sensitivity score based on an assessment of a first message received by a first electronic device from a second electronic device. The method also comprises the computer calculating a trust score based on the first message and previous messages between the first and second electronic devices. The method also comprises the computer calculating a risk score by aggregating the sensitivity score and the trust score. The method also comprises the computer authenticating a user of the second electronic device based on determining that the risk score exceeds a predefined threshold.

### CROSS REFERENCE TO RELATED APPLICATIONS

None

### FIELD OF THE DISCLOSURE

The present disclosure is in the fields of electronic communication services and risk monitoring operations therein. More particularly, the present disclosure is in the technical field of monitoring communications between electronic devices to determine riskiness of messages based on sensitivity of data to be transmitted and trustworthiness of parties to the messages.

### BACKGROUND OF THE DISCLOSURE

Online purchasers of products, insurance policy holders, account holders with financial institutions, and others consummating electronic transactions are frequently required to provide confidential information. Such confidential information includes social security numbers, credit card numbers, bank account numbers and insurance information. They may also be required to disclose confidential medical information including mental health and medication histories. Such persons usually do not personally know the people who are requesting the confidential information and they are not usually advised what their information will be used for, for how long it will be retained, and who will have access to it. Identity theft and electronic fraud have become worldwide problems due in part to the proliferation of electronic transactions. Account holders are rightfully concerned about the security of their confidential information.

### SUMMARY OF THE DISCLOSURE

In an embodiment, a method for assessment of risk is provided. The method comprises a computer calculating a sensitivity score based on an assessment of a first message received by a first electronic device from a second electronic device. The method also comprises the computer calculating a trust score based on the first message and previous messages between the first and second electronic devices. The method also comprises the computer calculating a risk score by aggregating the sensitivity score and the trust score. The method also comprises the computer authenticating a user of the second electronic device based on determining that the risk score exceeds a predefined threshold.

In an embodiment, a system for assessment of risk is provided. The system comprises a processor, a memory, and an application stored in the memory that when executed on the processor calculates a sensitivity score based on an assessment of a first message received by a first electronic device from a second electronic device. The system also calculates a trust score based on the first message and previous messages between the first and second electronic devices. The system also aggregates the sensitivity score and the trust score to calculate a risk score. The system also authenticates a user of the second electronic device based on a determination that the risk score exceeds a predefined threshold.

In an embodiment, a computer program embodied on a computer-readable medium is provided. The computer program comprises a set of instructions executable by at least one processor. The set of instructions comprises instructions to calculate a sensitivity score based on an assessment of a first message received by a first electronic device from a second electronic device. The set of instructions also comprises instructions to calculate a trust score based on the first message and previous messages between the first and second electronic devices. The set of instructions also comprises instructions to aggregate the sensitivity score and the trust score to calculate a risk score. The set of instructions also comprises instructions to authenticate a user of the second electronic device based on a determination that the risk score exceeds a predefined threshold.

### BRIEF DESCRIPTION OF THE DRAWINGS

FIG. 1 is a block diagram of a system for assessment of risk according to an embodiment of the present disclosure.

FIG. 2 is a block diagram of a system for assessment of risk according to an embodiment of the present disclosure.

FIG. 3 is a flowchart, of a method for assessment of risk according to an embodiment of the present disclosure.

### DETAILED DESCRIPTION OF THE INVENTION

Disclosed herein are systems, methods and computer programs embodied on computer-readable media for risk assessment and monitoring to improve security of electronic messaging. Calculations of risk scores based on various sender-related and recipient-related factors may lead to increased security measures including additional authentication of message senders.

Various aspects of systems and methods described herein provide solutions that afford more protection for sensitive personal information that may be transmitted during transactions, thereby supporting reduced risk and more secure identities. Such sensitive personal information includes bank and credit card account numbers, social security numbers, health insurance information, and driver license numbers.

The present disclosure provides systems and methods for evaluating messages transmitted between electronic devices. Evaluations are based at least on sensitivity factors of a message recipient and trust factors associated with the message sender. The sensitivity and trust factors are combined to calculate a risk factor. If the calculated risk factor exceeds a predetermined threshold, additional security measures may be necessary. In embodiments, some sensitivity factors may be applied to a sender of a message, for example in situations where a sending device has been stolen or otherwise compromised, for example hacked.

The disclosures provided herein seek to improve electronic messaging security. Stored factors that are examined in determining the sensitivity score include financial data, health data, medical data, and passwords of at least the recipient. These factors are assessed based on content and characteristics of the incoming message from the perspective of the message recipient. The sensitivity score is determined by applying algorithms and statistical techniques to these stored factors.

Reliability of the message sender as expressed by the trust score is based on accumulated data from observations of activity of the sender's electronic device. Such activity includes observed typing patterns, vocabulary use, and keystroke dynamics entered into the electronic device of the message sender. Observed activity may be compared with stored information about historical activity at the same electronic device. Such comparisons may be quantified and subjected to weightings and other algorithms in determining trust score.

Embodiments described herein may be used to provide systems and methods of risk monitoring to calculate risk scores. Such calculated risk scores, when exceeding predetermined thresholds, may result in message senders being authenticated or other security measures being taken. The sender may be required, for example, to enter a special password or credential, may be required to answer security questions, may be required to insert a card that contains a chip into a card reader, or may need to have a photograph taken of him/herself for facial recognition. Although embodiments described herein may be described with reference to specific examples, it will be evident that various modifications and changes may be made to such embodiments without departing from the broader spirit and scope of the teachings herein.

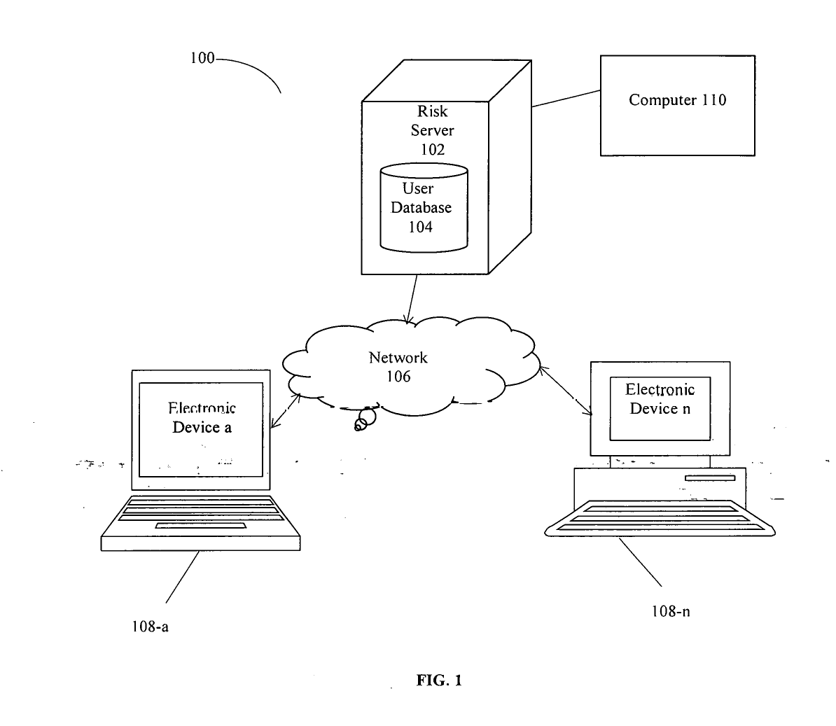

Turning to the figures, FIG. 1 is a block diagram of a system for assessment of risk according to an embodiment of the present disclosure. FIG. 1 depicts a system 100 provided herein comprising a risk server 102, a user database 104, a network 106, electronic devices 108-a through 108-n, and a computer 110. The risk server 102, while depicted as a hardware component, also includes at least one software application (not shown in FIG. 1) executing at least thereon that performs many of the interactions provided herein.

The risk server 102, the electronic devices 108-a through 108-n, and the computer 110 are computer systems. Computer systems are described in detail hereinafter. In embodiments the electronic devices 108-a through 108-n may be portable electronic devices, for example mobile telephones.

Users of electronic devices 108-a through 108-n may exchange confidential information in the course of a variety of transactions and for other purposes. Confidential information may be transmitted in some electronic messages. In many instances the users of the electronic devices 108-a through 108-n who are exchanging information are not known to each other. Information may be exchanged in simple electronic mail messages.

In an embodiment, a user of electronic device 108-a, for discussion purposes the sending party, may wish to send an electronic message to a user of electronic device 108-n, for discussion purposes the recipient party. The recipient party or another party may be concerned about the riskiness of the message, particularly if the sending party is requesting the recipient party to reply back with confidential information, for example the recipient party's social security number.

As provided herein, riskiness of the exchange may be viewed as a combination of sensitivity factors and trust factors. The sensitivity factors may be associated with the recipient party and his/her concern about the security of his/her confidential information. The trust factors may be associated with the sending party and may be generated by examining activity at the sending party's electronic device 108-a.

The risk server 102, which monitors activity across the network 106, may intercept the electronic message originated by the sending party and sent to the recipient party. The risk server 102, which may consult the user database 104, determines sensitivity factors for the electronic message. The sensitivity factors include financial data, health data, medical data, personal identifiers, and passwords associated with at least the recipient party. Other means of bypassing security systems are also considered. Based on examination of the sensitivity factors, the risk server 102 generates a sensitivity score for the electronic message.

The risk server 102, which may again consult the user database 104, determines trust factors for the electronic message. The trust factors are associated with the sending party and include stored observations about typing patterns, vocabulary use, and keystroke dynamics associated with the sending party's electronic device 108-a. The risk server 102 compares typing patterns, vocabulary use, and keystroke dynamics observed for the present electronic message with stored data about typing patterns, vocabulary use, and keystroke dynamics observed for previous messages originated by the electronic device 108-a. Based on such comparison, the risk server 102 generates a trust score for the electronic message. The risk server 102 may also examine various other aspects of the use of the sending party's electronic device 108-a, for example days of the week and limes of day of use, power on and power off habits, and application and website access.

Having generated a sensitivity score and a trust score for the electronic message, the risk server 102 then uses at least these two scores to calculate a risk score for the electronic message. The risk score may be calculated by the risk server 102 factoring at least the sensitivity score and the trust score into at least one proprietary algorithm or formula. The risk score is an expression of the overall riskiness of the electronic message.

Having generated the risk score, the risk server 102 then consults stored information about historic risk scores for a plurality of combinations of sensitivity scores, trust scores, and other data. The stored information may be stored in the user database 104. The risk server 102 compares the risk score generated for the present electronic message with stored information about historic risk scores. If the presently generated risk score exceeds a predetermined threshold of risk score, further security measures may be necessary, including authenticating the user of the sending electronic device 108-a.

Aggregation of the sensitivity score and the trust score may comprise at least one of blending and analyzing behavior data and/or activity data. Quantitative techniques and algorithms may be applied to such data. The system 100 may track and analyze transmissions between two or more computers and associated users' behaviors and identify suspicious activity.

Different algorithms may be used to assess fraud activities and distinguish unusual but benign activity from truly hostile and malign activity. The activity data is based on the historical records of the sending user's behavior patterns which may include typing patterns, vocabulary, keystroke patterns and the like. The risk score may be increased or decreased based on the sensitivity score and the trust score which may be based on the actions of the users.

The user database 104 contains information about levels of sensitivity regarding areas of personal information including financial data, health data, medical data, personal identifiers, and passwords. The user database 104 does not store the personal information itself, just measures of the sensitivity about certain items of personal information. As noted, the user database 104, also contains stored observations about typing patterns, vocabulary use, and keystroke dynamics associated with electronic devices 108-a through 108-n for many sending parties. While depicted in FIG. 1 as a component of the risk server 102, the user database 104 may be stored in components physically separate from the risk server 102.

The computer 110 may be used by an administrator of the system 100. The computer 110 may be used to examine results generated by the risk server 102 and manipulate data stored in the user database 104.

The network 106 promotes communication between the components of the system 100. The network 106 may be any communication network including a public data network (PDN), a public switched telephone network (PSTN), a private network, and/or a combination thereof.

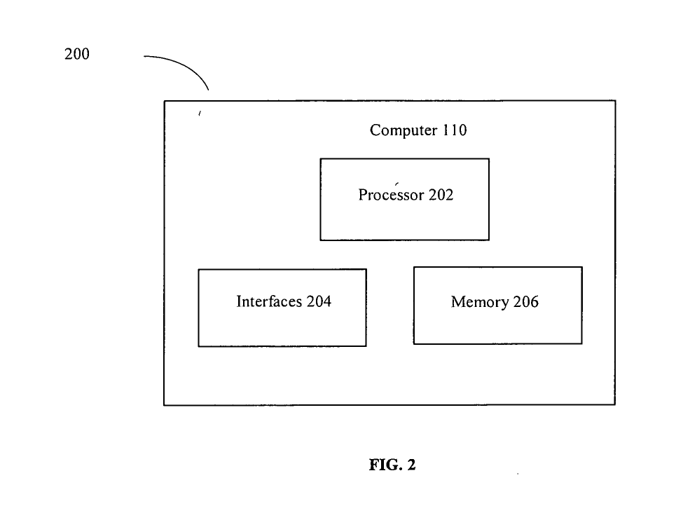

FIG. 2 depicts a system for assessment of risk according to an embodiment of the present disclosure. FIG. 2 depicts a system 200 of an exemplary computer system. While labeled as computer 110 and corresponding to computer 110 of system 100, the components of system 200 may also be exemplary of components of the risk server 102 and electronic devices 108-a through 108-n provided by the system 100.

The system 200 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 is configured to retrieve and execute computer-readable instructions stored in the memory 206.

The I/O interface 204 may include a variety of software and hardware interfaces; for example, a web interface, a graphical user interface, and/or the like. The I/O interface 204 may allow the system 200 to interact with a user directly or through the electronic devices 108-a through 108-n. Further, the I/O interface 204 may enable the system 200 to communicate with other computing devices, such as web servers and external data servers (not shown). The I/O interface 204 may facilitate multiple communications within a wide variety of networks and protocol types, including wired networks; for example, LAN, cable, etc., and wireless networks, such as WLAN, cellular, or satellite. The I/O interface 204 may include one or more ports for connecting a number of devices to one another or to another server.

One or more local area networks, or LANs, for example the network 106 provided by the system 100, may be included in the enterprise computing environment. A LAN is a network that usually spans a relatively short distance. Typically, a LAN is confined to a single building or group of buildings. Each individual computer system or device connected to the LAN preferably has its own Central Processing Unit, or processor, with which it executes programs, and each computer system is also able to access data and devices anywhere on the LAN. The LAN thus allows many users to share printers or other devices as well as data stored on one or more file servers. The LAN may be characterized by any of a variety of network topologies (i.e., the geometric arrangement of devices on the network), protocols (i.e., the rules and encoding specifications for sending data, and whether the network uses a peer-to-peer or client/server architecture), and media (e.g., twisted-pair wire, coaxial cables, fiber optic cables, radio waves).

The memory 206 may include any computer-readable medium known in the art, including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes.

In one implementation, users of electronic devices 108-a through 108-n may access the system 200 via the I/O interface 204. The electronic devices 108-a through 108-n may consist of an installed client application. As described above in connection with the system 100, the system 200 is used to facilitate monitoring risk assessment based on communications between the electronic devices 108-a through 108-n.

In some embodiments, instructions associated with operations performable through processor 202 and programming thereof may be tangibly embodied on a non-transitory medium (e.g., a Compact Disc (CD), a Digital Video Disc (DVD), a Blu-ray disc®, a hard drive) readable and executable through an electronic device. The aforementioned instructions may also be downloaded from the Internet or other network including the network 106 of the system 100 into a memory, for example memory 206 or another non-transitory medium. All reasonable variations are within the scope of the exemplary embodiments discussed herein.

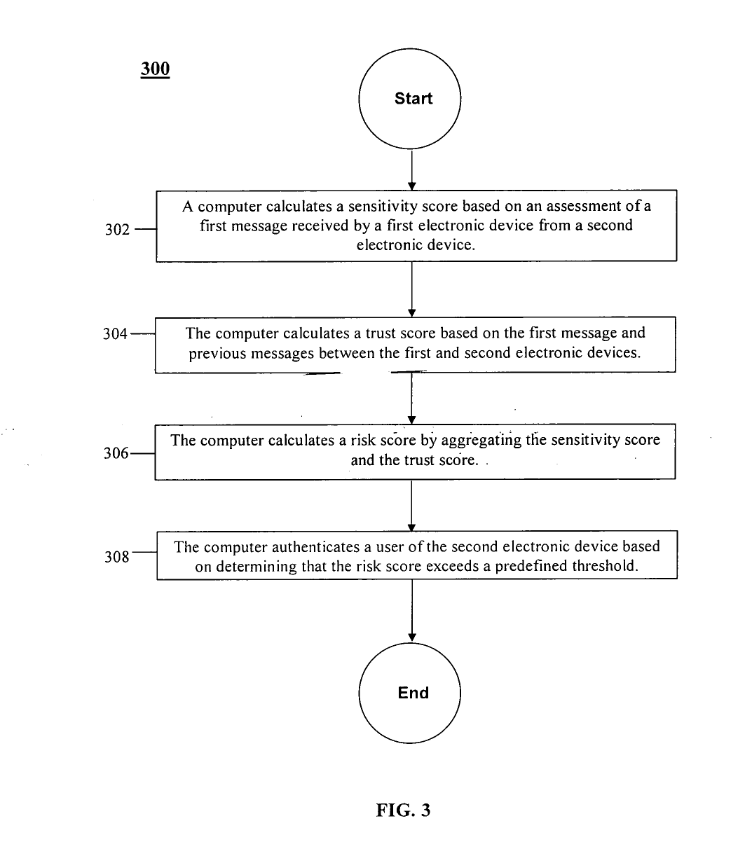

FIG. 3 is a flowchart of a method of risk assessment according to an embodiment of the present disclosure. FIG. 3 depicts steps of a method 300 wherein the steps are executed on components provided by the system 100 and system 200 provided herein.

Beginning at block 302, a computer calculates a sensitivity score based on an assessment of a first message received by a first electronic device from a second electronic device. At block 304, the computer calculates a trust score based on the first message and previous messages between the first and second electronic devices.

At block 306, the computer calculates a risk score by aggregating the sensitivity score and the trust score. At block 308, the computer authenticates a user of the second electronic device based on determining that the risk score exceeds a predefined threshold. The method 300 terminates thereafter.

Although the above descriptions set forth preferred embodiments, it will be understood that there is no intent to limit the embodiment of the disclosure by such disclosure, but rather, it is intended to cover all modifications, substitutions, and alternate implementations falling within the spirit and scope of the embodiment of the disclosure. The embodiments are intended to cover capabilities and concepts whether they be via a loosely coupled set of components or they converge into one or more integrated components, devices, circuits, and/or software programs.

What is claimed is:

1. A method, comprising:
a computer calculating a sensitivity score based on an assessment of a first message received by a first electronic device from a second electronic device;
the computer calculating a trust score based on the first message and previous messages between the first and second electronic devices;
the computer calculating a risk score by aggregating the sensitivity score and the trust score; and
the computer authenticating a user of the second electronic device based on determining that the risk score exceeds a predefined threshold.

2. The method of claim 1, wherein the assessment of the first message comprises measurement of a sensitivity of at least one of content and characteristics of the first message to a user of the first device.

3. The method of claim 2, wherein measurement of the sensitivity comprises at least consideration of quantified sensitivity levels regarding financial data, health data, medical data, personal identifiers, and passwords.

4. The method of claim 1, wherein aggregating the sensitivity score and the trust score comprises applying quantitative techniques and algorithms to the scores.

5. The method of claim 1, wherein the trust score supports determinations of whether the user of the second electronic device at the time of the first message is historically associated with the second electronic device.

6. The method of claim 1, wherein the trust score is calculated based at least on accumulated data generated from observations of at least one of typing patterns, vocabulary use, and keystroke dynamics associated with the second electronic device.

7. A system, comprising:
a processor;
a memory; and
an application stored in the memory that when executed on the processor:
calculates a sensitivity score based on an assessment of a first message received by a first electronic device from a second electronic device,
calculates a trust score based on the first message and previous messages between the first and second electronic devices,
aggregates the sensitivity score and the trust score to calculate a risk score, and
authenticates a user of the second electronic device based on a determination that the risk score exceeds a predefined threshold.

8. The system of claim 7, wherein the assessment of the first message comprises measurement of a sensitivity of at least one of content and characteristics of the first message to a user of the first device.

9. The system of claim 8, wherein measurement of the sensitivity comprises at least consideration of stored factors comprising at least one of financial data, health data, medical data, personal identifiers, passwords and other means of bypassing security systems.

10. The system of claim 7, wherein aggregating the sensitivity score and the trust score comprises examining at least one of behavior data and activity data.

11. The system of claim 7, wherein the trust score supports determinations of whether the user of the second electronic device at the time of the first message is historically associated with the second electronic device.

12. The system of claim 7, wherein the trust score is calculated based at least on accumulated data generated from observations of at least one of typing patterns, vocabulary use, and keystroke dynamics associated with the second electronic device.

13. A computer program embodied on a computer-readable medium, the computer program comprising a set of instructions executable by at least one processor, the set of instructions comprising:
instructions to calculate a sensitivity score based on an assessment of a first message received by a first electronic device from a second electronic device,
instructions to calculate a trust score based on the first message and previous messages between the first and second electronic devices,
instructions to aggregate the sensitivity score and the trust score to calculate a risk score, and
instructions to authenticate a user of the second electronic device based on a determination that the risk score exceeds a predefined threshold.

14. The computer-readable medium of claim 13, wherein the assessment of the first message comprises measurement of a sensitivity of at least one of content and characteristics of the first message to a user of the first device.

15. The computer-readable medium of claim 14, wherein measurement of the sensitivity comprises at least consideration of stored factors comprising at least one of financial data, health data, medical data, personal identifiers, passwords and other means of bypassing security systems.

16. The computer-readable medium of claim 13, wherein aggregating the sensitivity score and the trust score comprises examining at least one of behavior data and activity data.

17. The computer-readable medium of claim 13, wherein the trust score supports determinations of whether the user of the second electronic device at the time of the first message is historically associated with the second electronic device.

18. The computer-readable medium of claim 13, wherein the trust score is calculated based at least on accumulated data generated from observations of at least one of typing patterns, vocabulary use, and keystroke dynamics associated with the second electronic device.
